(19) United States
(12) Patent Application Publication
(10) Pub. No.: US 2025/0223979 A1
(43) Pub. Date: Jul. 10, 2025

(54) Piston Accumulator

(71) Applicant: Hydac Technology GmbH, Sulzbach / Saar (DE)

(72) Inventor: Peter Kloft, Ransbach-Baumbach (DE)

(73) Assignee: Hydac Technology GmbH, Sulzbach / Saar (DE)

(21) Appl. No.: 18/849,409

(22) PCT Filed: Mar. 1, 2023
(86) PCT No.: PCT/EP2023/055113

§ 371 Date: Sep. 20, 2024

(30) Foreign Application Priority Data
Mar. 22, 2022 (DE) 10 2022 000 976.5

(51) Int. Cl. F15B 1/24; F03D 1/06

(52) U.S. Cl. CPC F15B 1/24; F03D 1/06; F05B 2260/96

(57) ABSTRACT

The disclosure relates to a piston accumulator comprising an accumulator housing and a separator piston which is longitudinally moveably arranged therein and separates two media chambers from one another within the accumulator housing, wherein the accumulator housing is elastically formed in a sandwich-type structure from individual, partially differing layers in such a way that, with the influence of at least one external force, it allows for a curvature as a whole, starting from a starting state, and it returns to the starting state with the removal of the respective force.

### CROSS-REFERENCE TO RELATED APPLICATIONS

This application claims priority to German Patent Application No. DE 10 2022 000 976.5, filed on Mar. 22, 2022 with the German Patent and Trademark Office. The contents of the aforesaid Patent Application are incorporated herein for all purposes.

The disclosure relates to a piston accumulator comprising an accumulator housing and a separating piston arranged so as to be longitudinally movable therein, which separates two media chambers from each other within the accumulator housing.

Piston accumulators of this type are customary. They are widely used in hydraulic systems, for example for energy storage, for emergency actuations, for damping mechanical shocks or pressure surges, for vehicle suspension and the like.

DE 101 61 797 C1 discloses a piston accumulator having an accumulator housing, a piston therein which separates a gas-side media chamber from a fluid-side media chamber, which piston is movable in the axial direction, a housing cover which closes the fluid-side media chamber, which housing cover has a fluid passage opening, and a stop device which limits the path of the piston and has contact surfaces which are formed on the piston and on the housing cover and surround the fluid passage opening, which contact surfaces bear against each other when the piston is in the end position close to the housing cover, the contact surfaces of the stop device being provided as sealing surfaces, at least one of which has a convexly curved contour for uninterrupted line contact with the other contact surface, the piston and the housing cover being made of steel materials with ductility selected in each case with a view to an optimum sealing effect at their contact line. Due to this configuration of the contact surfaces, the stop device limiting the piston travel forms a metallic seal in double function, which seals the piston against the fluid passage opening of the fluid-side chamber when the piston is in the end position, and the line contact brought about by the curved configuration of at least one of the contact surfaces results in a secure seal due to the high contact pressure of the metallic seal arrangement, so that complete gas tightness is guaranteed over very wide temperature ranges, which can include lowest values of −40° C.

Due to this feature configuration of permanent plastic deformation prior to a possible fracture, such piston accumulators can also be used in tough outdoor environments under extreme environmental conditions. For example, DE 10 2016 003 345 B4 shows such an application as part of a balancing device for compensating the imbalance of rotors of wind turbines, consisting of at least one
rotor blade with two piston accumulators extending along its longitudinal orientation, the separating pistons of which are each subject to a pretension via a compressible medium and which are connected to each other in a media-conducting manner via a fluid line using an incompressible medium,
control valve which, when connected in the respective fluid line, establishes the media connection between the two piston accumulators of a pair or separates them from each other,
acceleration sensor,
rotor position sensor, and
control system for evaluating the sensor data and actuating at least one pair of piston accumulators by controlling the control valve.

By means of this balancing device, it is possible to balance the respective rotor of a wind turbine accordingly during operation, which is regularly necessary since imbalances can develop in particular during operation, for example due to dirt deposits on the rotor blades or due to uneven incident wind flow, for example when turbulence occurs during wind turbine operation.

The rotor blades are also regularly subject to deformations during operation of the wind turbine, for the description of which kinematic models are used that are able to describe the deformations of a rotor blade, for example based on the assumptions of an Euler-Bernoulli beam. The deformations on the respective rotor blade which can be determined theoretically in this respect correspond to practical measured value acquisitions, which are preferably based on a combination of photogrammetric and laser scanner measurements. In any case, rotor blade deformations regularly occur in this respect in practice, in the form of reversible deflections along the longitudinal axis of the rotor and, according to the teaching of DE 10 2016 003 345 B4, the piston accumulators hinged to the rotor blades must be able to follow these deformations which are the result of a changing bending curve caused by the changing incident wind flow together with turbulence occurring during operation. The piston accumulators, which are regularly constructed of solid steel materials, are then unable to follow the bending curve of the rotor blade as it changes over time, despite the aforementioned ductility of subcomponents, which frequently leads to failure of the connection point between piston accumulator and rotor blade and thus to the balancing device as a whole becoming unusable.

Irrespective of the initial situation for wind turbines described above, piston accumulators can also be exposed to other changing alternating bending stresses, for example if the piston accumulator is exposed to strong vibrations during the operation of a hydraulic system, such as used in aircraft, rockets, military vehicles, agricultural machines, etc.

### SUMMARY

A need exists to provide an improved piston accumulator allowing safe operation, even if bending stresses should occur

The need is addressed by the subject matter of the independent claim(s). Embodiments of the invention are described in the dependent claims, the following description, and the drawings.

### BRIEF DESCRIPTION OF THE DRAWINGS

FIG. 1 shows edge end regions of an example accumulator housing, which is constructed as a composite liner in sandwich design, in the manner of a longitudinal section;

FIG. 2 shows an end face view of a housing cover for the accumulator housing according to FIG. 1;

FIG. 3 shows an enlarged detail of an end portion of the accumulator housing denoted by X in FIG. 1;

FIG. 4 shows a schematic diagram of a possible curvature of the accumulator housing according to FIG. 1 when a bending force is introduced in the direction of the arrow;

FIGS. 5 and 6 show an example separating piston for the accumulator housing according to FIG. 1 in lateral view and end-face view;

FIG. 7 shows the separating piston shown in FIG. 5, inserted in an accumulator housing according to FIG. 1; and

FIG. 8 shows the use of a piston accumulator according to the embodiment shown in FIG. 7 in a wind turbine with three rotating rotor blades.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, the accumulator housing in sandwich design is elastically constructed from individual layers, some of which are different from one another, in such a manner that under the action of at least one external force, starting from an initial state, it allows for a curvature as a whole and returns to the initial state with the removal of the respective force. Thus, a piston accumulator is provided which, even with large deflections of the accumulator housing under load, returns to its initial state without deformation when the same load is removed and at the same time remains functional even in the event of deflection. The said sandwich design, which allows linear-elastic behaviour (Hooke's law) to be achieved for the accumulator housing, significantly contributes to this. In addition, due to the sandwich structure using multi-layer technology, a very lightweight construction is implemented which, in conjunction with third-party components such as the rotor blades of a wind turbine, leads to extremely beneficial operating behaviour as only small masses need to be moved.

In some embodiments, it is provided that, as part of the sandwich structure, the innermost layer of the accumulator housing consists of a first layer which is impermeable to gas and that the respective subsequent outward layer is formed of a fibre winding. For example, in terms of wall thickness, the first layer is a thin steel tube which is for example produced by means of flow-forming and which forms the running surface for the separating piston on the inner circumference. In this respect, the steel tube forms a steel liner and, even in the deformed state, forms a smooth running surface for the outer circumference of the separating piston with its guide and sealing systems. Furthermore, it is guaranteed in any case that the steel liner is impermeable to gas and there is no risk of the working gas permeating through the plastic or of leaks as a result of resin fractures, so-called fibre breaks in the laminate, if the intention is to replace the inner steel liner with a plastic liner as part of an improved lightweight construction.

The respective fibre winding for the accumulator housing, which follows the steel liner, has a different winding direction than the preceding winding direction in the winding sequence in each case. The fibres to be wound in each case are aligned, for example according to the load paths occurring, so that, for example, a winding in a radial direction of less than 90°, around the cylindrical steel liner, can be followed by a further fibre winding whose respective fibre alignment is between 0° and 45° and subsequently another winding can for example take place in an exclusively radial direction, i.e., in the direction of a load less than 90°, which is perpendicular to the axial path of alignment of the tubular steel liner. Less than 90° means, for example, winding directions of 87° or 88°. Depending on the strength requirements, additional fibre windings can be applied with the correspondingly same or a different orientation. To influence the strength in different directions, woven fabrics or layered scrims, which must be produced prior to contact with the matrix, can be used instead of individual fibres. In any case, a fibre composite material should also be produced using the individual fibres to be wound which, as a multi-phase or mixed material, generally consists of at least two main components, namely the reinforcing fibres to be wound and a bedding matrix, regularly formed from a suitable filler and adhesive between the fibres. To achieve a high-strength fibre composite, carbon materials are for example used for the present piston accumulator. However, other chemical fibers can also be used, in particular glass, aramids and high-strength polyester, etc. Overall, a type of CFRP tube is formed, which has the thin steel liner on the inside and the individual fiber layers together with the steel liner form an inherently pressure-resistant, highly elastic liner composite.

In some embodiments, it is provided that, on at least one free end face of the accumulator housing, a connecting part is partially enclosed by at least part of the fibre windings. It is for example provided that the connecting part is at least partially penetrated on its cylindrical inner circumference by the innermost layer and has an annular receiving groove on the outer circumference for receiving fibre layers of the individual windings. For example, it is provided that the receiving groove is at least partially bounded by a ramp against which at least one inner fibre winding is placed and which is overlapped by at least one subsequent fibre winding that is further outward-facing. In this way, the respective fibre winding at the free end of the accumulator housing can be connected in a high-strength manner to the connecting part which, in this respect, forms a receiving flange for attaching a cover part that closes the accumulator housing at each end. The aforementioned cover part can be bonded to the free end face of the connecting part so that the interior of the accumulator housing is correspondingly sealed with respect to the environment. Furthermore, a high-strength connection can be created if the respective cover part is firmly screwed to the connecting part. If the cover part is bonded to the connecting part, it can for example be provided that the liner winding is guided at least partially over the cover part so as in this way to create a high-strength connection between the accumulator housing and the cover part. If necessary, however, the cover part requires a connection point, for example in the middle, regularly in the form of a connection hole to connect the interior of the accumulator housing to a fluid circuit or to ensure filling of one of the two media chambers with the working gas. Depending on the configuration of the accumulator housing, at least the one end of the tube can be constructed as a hemisphere or using a type of dished head instead of the cover part mentioned above. If possible, the corresponding end side is then also to be provided with a fibre winding so that the interior of the accumulator housing can accordingly be configured to be pressure-resistant. In any case, due to the configuration of the liner, it is ensured that, within the usual limits, the accumulator housing can absorb a bending force in such a manner that a relevant curvature is created which, after the bending force is removed, allows the accumulator housing to return to the initial state without permanent deformations occurring due to the elasticity of the liner composite.

To achieve a firm connection of the respective fibre winding to the associated connection part, it is further provided that a plurality of retaining pins engage through the liner composite with the fibre windings, which have a constant radial distance from each other and in this way connect the fibre winding to the connection part in a defined manner. Despite this connection, the flexibility of the accumulator housing is not affected.

In some embodiments, use of a piston accumulator, in lightweight construction as described above, is provided for a wind turbine as part of a balancing device to compensate for the imbalance of the rotors of such a wind turbine, at least one rotor of which is firmly connected to the accumulator housing of the piston accumulator at discrete fixing points and in such a way that, when the rotor is bent, the accumulator housing can follow this bending path without being impaired in its function. This thus has no equivalent in prior art.

The piston accumulator according to the invention is explained in greater detail below with reference to an embodiment according to the drawing. Specific references to components, process steps, and other elements are not intended to be limiting. The drawings are not to scale.

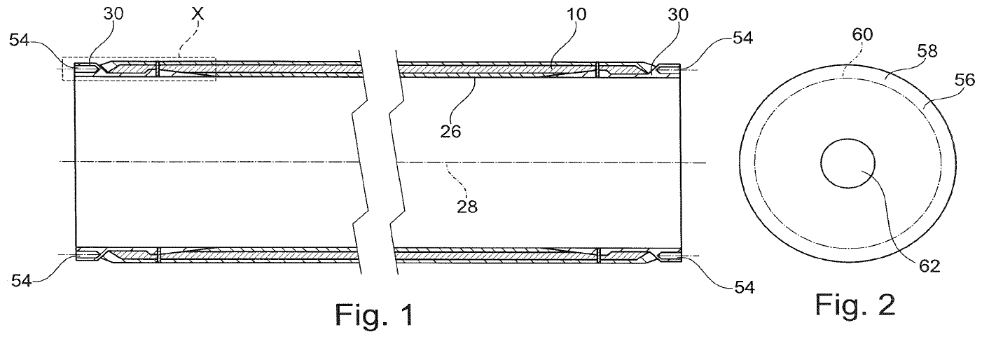

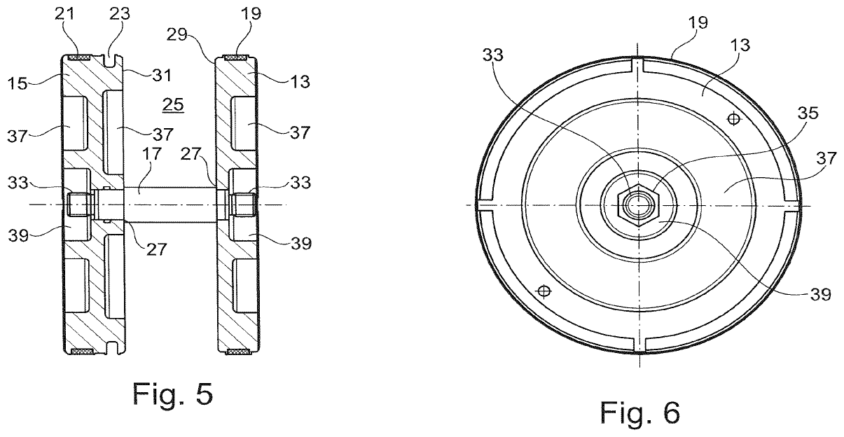

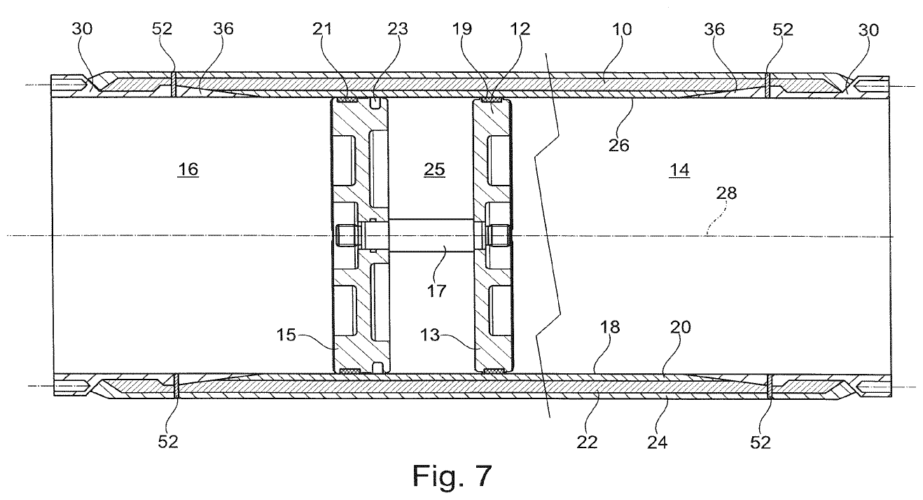

FIG. 1 shows in longitudinal section an accumulator housing 10 of a piston accumulator and FIG. 7 shows the accumulator housing 10 with a separating piston 12 arranged so as to be longitudinally movable therein, which separates two media chambers 14, 16 from each other within the accumulator housing 10 and which is shown in greater detail in FIGS. 5 and 6. In this case, the media chamber 14 can be used to hold a working gas, such as in the form of nitrogen gas, and the further media chamber 16 is used to hold an operating fluid, such as hydraulic oil. Since the accumulator housing 10 can have a correspondingly large overall length, for example in the order of magnitude of 2 metres, in FIGS. 1 and 7 the accumulator housing 10 is only shown in the region of its ends; in the central region, however, the accumulator housing 10 also corresponds in this respect to the configuration of the end region at the edge, as far as the liner structure of the accumulator housing 10 is concerned. Accordingly, the accumulator housing 10 in sandwich design is elastically constructed from individual layers 18, 20, 22 and 24, some of which are different from one another, in such a manner that under the action of at least one external force F, starting from an initial state as indicated in FIGS. 1 and 7, it allows for a curvature as a whole, according to the simplified diagram of FIG. 4, and with the removal of the respective force F, the accumulator housing 10 elastically returns to the initial state. In this respect, the sandwich design thus allows a linear-elastic behaviour for the accumulator housing 10.

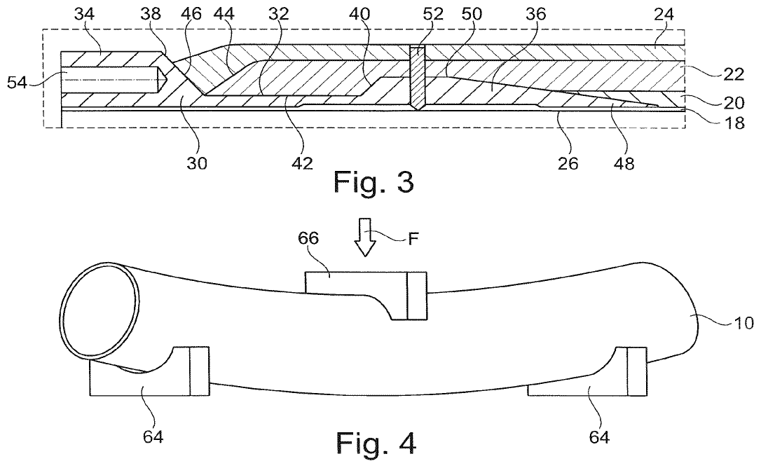

As part of the said sandwich structure, the innermost layer 18 of the housing 10 is impermeable to gas and the respective subsequent outward layers 20, 22 and 24 are formed of a fibre winding. The aforementioned layer composite is shown in particular in FIG. 3, which is an enlarged reproduction of the detail denoted by X shown in FIG. 1. The innermost layer 18 is designed in terms of wall thickness as a thin steel tube which is for example produced in one piece by means of flow-forming and which in this respect forms the smooth running surface 26 for the separating piston 12 on the inner circumference, according to the diagram in FIG. 7. The steel liner 18 extends over the entire length of the accumulator housing 10 up to the free front end thereof. The respective fibre winding for the accumulator housing 10 has a different winding direction than the preceding winding direction in the winding sequence in each case. The respective fibre winding consists for example of carbon fibre material and the fibre winding of the layer 20 is wound onto the steel layer 18 in the circumferential direction, i.e. has a winding direction of less than 90° to the longitudinal direction 28 of the accumulator housing 10. In contrast, the subsequent layer 22 can deviate by 0° to 45° from the aforementioned less than 90° winding direction; however, it is also possible to apply the corresponding layer 22 to the winding 20 largely parallel to the longitudinal direction 28 of the accumulator housing 10. Other winding directions are possible here, as is the application of further layers depending on the respective application and depending on the required rigidity for the overall accumulator housing 10. The outermost layer 24 again consists of a fibre winding in the same direction as the wound layer 20, i.e. with a radial winding direction at less than 90° to the longitudinal direction 28, for example 87° or 88°.

As further shown in FIG. 3 in particular, an annular connecting part 30 is present in each case at both ends of the accumulator housing 10, which connecting parts are configured as identical parts. The annular or cylindrical connecting part 30 is penetrated on its inner circumference by the steel liner 18 and opens out on the face at the free end of the connection part 30. On the outer circumference, the respective connecting part 30 has an annular receiving groove 32 for receiving fibre layers of the two outermost windings 22 and 24. The receiving groove 32 is bounded on its one side by a connecting flange 34 and on its inner side by a fixing ramp 36. Both the connecting flange 34 and the fixing ramp 36 have contact surfaces 38, 40 extending obliquely on their adjacent sides, which in a notional extension form a cone with each other in the direction of a groove base 42. In this case, the fixing ramp 36 is overlapped by the third layer 22, which in this respect comes into direct contact with the groove base 42 of the receiving groove 32. In doing so, the third layer 22 tapers to a point at its free front end and ends at the base of the obliquely extending contact surface 38. The pointed end of the third layer 22 bounds an obliquely extending wall part 44 of this third layer 22, which forms a further V-shaped engagement groove 46 with the obliquely extending contact surface 38 of the connecting part 30, which engagement groove likewise designed as an annular groove is used to engage the free end of the outer layer 24. By contrast, the second layer 20, which follows the steel layer 18 in the winding sequence, nestles against a ramp part 48 of the fixing ramp 36, which in this region is adjacent at the foot end to the innermost layer 18 at a slight angle of inclination. In this way, a secure layer or liner composite of the individual layers 18, 20, 22 and 24 is achieved in their free end-face region via the respective connecting part 30 with connecting flange 34 and fixing ramp 36 as part of the sandwich design.

At the point of transition between steeply sloping contact surface 40 and, in contrast, the flat rising surface of the ramp including the ramp part 48, the fixing ramp 36 as shown in the diagram of FIG. 3 has a circumferential or engagement surface 50, extending substantially horizontally, through which individual, for example metallic retaining pins 52 pass, which are evenly distributed around the accumulator housing 10 in the radial direction at discrete distances from one another and firmly connect the layer composite comprising the individual layers 18, 20, 22 and 24 to the connecting part 30 and in this way ensure a secure layer composite.

Pin recesses 54, which are evenly distributed around the outer circumference of the connecting flange 34, are located on the free end faces of the respective connecting flange 34 of the connecting part 30. The respective cover part 56 can be pinned to the associated connecting part 30 via the aforementioned pin recesses 54, such a cover part 56 being present at each free end of the accumulator housing 10. The aforementioned associated pins, which are not shown in greater detail, are to be attached to the cover part 56 along an annular surface 58 provided therefor, the notional inner curve of which is shown by a dot-dash line 60. In addition, the aforementioned annular surface 58 is used on its inner side directed towards the accumulator housing 10 for the application of an adhesive, in this way to create a media-tight connection between the two media chambers 14, 16 and the environment. Furthermore, in the context of an embodiment not shown in greater detail, it is possible to connect the respective cover part 56 to the accumulator housing 10 via a fibre winding in a media-tight and pressure-resistant manner. In the central region of each cover part 56, there is a connection opening 62 which can be sealed tightly to the media chamber 14 on the gas side of the accumulator housing 10 and remains open on the liquid side in order to connect the further media chamber 16 to a conventional hydraulic circuit (not shown). To separate the two media chambers 14, 16, i.e. a gas side from a liquid side, in a media-tight manner, a separating piston 12 is inserted into the accumulator housing 10 in a longitudinally movable manner according to the diagram in FIG. 7, said separating piston being shown in greater detail in FIGS. 5 and 6, FIG. 6 showing an end-face view from the right of the separating piston 12 according to FIG. 5. Accordingly, the separating piston 12 has two piston parts 13, 15 which are formed as discs with the same outer diameter and which are securely held at a distance from each other via an elastically flexible piston rod 17, the piston rod 17, under the action of at least one external force F, allowing for a curvature as a whole starting from an initial state and returning to its initial state with the removal of the respective force F. In this way, the double-disc piston arrangement of the separating piston 12 is suitable for following a curvature of the accumulator housing 10, as shown by way of example in FIG. 4. Similarly to the two piston parts 13, 15, the piston rod 17 consists of a suitable metal material, the piston rod 17 for example being configured to be more flexible to bending than the discs 13, 15. In particular, the piston rod 17 prevents the relatively thin discs for the two piston parts 13, 15 from tilting during guidance along the running surface 26 in the accumulator housing 10 and thus inhibiting the movement sequence for the separating piston 12.

The one piston part 13, which is directed towards the one media chamber 14, has a guide strip 19 on the outer circumference and the other piston part 15, which is directed towards the further media chamber 16, has a further guide strip 21 and a ring seal 23 made of a conventional elastomer material. The two annular guide strips 19, 21 are configured as identical parts and consist of a material with good sliding properties, which is for example correspondingly temperature-resistant, such as PTFE material. Both the guide strips 19, 21 and the ring seal 23 are each inserted in ring-like receiving grooves in the associated piston parts 13, 15 and slide along the inner circumference of the accumulator housing 10 in the form of the running surface 26. In this respect, as shown in the diagram of FIG. 5, the ring seal 23 is arranged between the two guide strips 19, 21 on the other piston part 15. Due to the disc-shaped arrangement of the two piston parts 13, 15, an annular space 25 is formed therebetween, which contains the medium of the one media chamber 14, in particular in the form of the working gas. To prevent the aforementioned tilting of the disc-shaped piston parts 13, 15 and to be able nevertheless to ensure that the separating piston 12 as a whole can follow the curved course of an accumulator housing 10 which is under bending stress, the distance of the two disc-shaped piston parts 13, 15 from each other is less than ⅓ of the diameter of the respective piston part 13, 15. Furthermore, to ensure a reliable course of displacement, the disc thickness of the piston part 13 with the guide strip 19 is selected smaller than the disc thickness of the other piston part 15 with the further guide strip 21 and the sealing ring 23. For unobstructed operation, it is provided in addition that the piston rod 17 with its two opposing shoulders 27 merges flat into the mutually facing free end faces 29, 31 of the two piston parts 13 and 15, respectively. Accordingly, the piston rod 17 engages through the respective piston part 13, 15 with its end regions directed away from each other and the piston rod 17 is fixed to this associated piston part 13, 15 along this end region via a threaded section 33 by means of a conventional lock nut 35, only shown in the diagram of FIG. 6.

As can further be seen from FIGS. 5, 6 and 7, the discs of the two piston parts 13, 15 are provided with annular recesses 37 which, on the one hand, serve to save weight and, in addition, increase the elasticity for the discs 13, 15. The recesses 37 are configured substantially identically on the opposing end faces of the two piston parts 13, 15 and are arranged concentrically to a central recess 39 which receives the respectively associated threaded section 33 of the piston rod 17 and the lock nut 35. Furthermore, an annular recess 37, which is widened both on the outer circumference and on the inner circumference, is present on the inner end wall of the piston part 15 in a concentric arrangement to these recesses 37. The separating piston 12 configured to be elastic in this way can also be used for “normal” accumulator housings 10; accumulator housings 10 of the type presented can also be used with “conventional” separating pistons.

FIG. 4 now shows the supported accumulator housing 10 on two bearing blocks 64 and a compressive force F is applied from above at a central introduction point 66 in such a manner that the accumulator housing 10 bends as shown in FIG. 4. In FIG. 4, the accumulator housing 10 is shown in idealised form, in particular without the two end cover parts 56. If the force F is removed, the accumulator or accumulator housing 10 returns to its original position according to the diagram of FIGS. 1 and 7. It is understood that when the accumulator housing 10 is held at the introduction point 66 and the force is applied from below via the bearing blocks 64, a deflection comparable to that shown in FIG. 4 occurs.

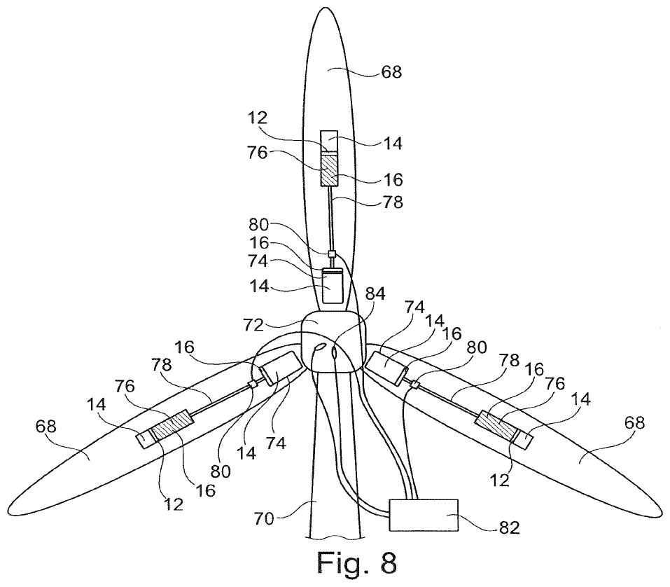

If the piston accumulator is fitted as part of a balancing device for compensating the imbalance of rotors of wind turbines, as shown by way of example in FIG. 8, the fixing takes place along the two bearing blocks 64 on one of the two blade sides of the respective rotor blade 68. In FIG. 8, the partially shown tower of a wind turbine is denoted by 70. In the manner usual with wind turbines, a machine house 72, also referred to in technical terms as a “nacelle”, is rotatably arranged about the vertical axis of the tower 70 at the upper end of said tower 70 so that it can be rotated forwards and backwards by two to three revolutions. A rotor hub for three rotor blades 68 of a three-blade rotor, which hub is rotatably mounted on the nacelle 72, is not visible in the simplified diagram of FIG. 8. Within each rotor blade 68 is a pair of piston accumulators comprising an inner piston accumulator 74 and an outer piston accumulator 76. The respective piston accumulator 74, 76 is basically constructed as shown in FIG. 7 with corresponding end parts, such as the respective cover part 56, at the ends. In this case, the respective piston accumulator 74, 76 is attached to the associated rotor blade 68 via the assigned bearing blocks 64.

The inner piston accumulator 74 in each case is arranged in the region of the blade root adjacent to the rotor hub and the outer piston accumulator 76, on the other hand, is offset toward the respective blade tip by a distance which extends along the longitudinal orientation of the respective rotor blade 68. It is for example provided that the outer piston accumulator 76 is dimensioned to be slenderer than the inner piston accumulator 74 of the pair, corresponding to the smaller installation space available close to the blade tip within the respective rotor blade 68.

In the inner piston accumulator 74, the media or working chamber 14, which carries the compressible pressure medium such as the working gas, for example in the form of nitrogen gas, is directed towards the blade root, while in the outer piston accumulator 76, the working chamber 14, which carries the compressible medium, is directed towards the blade tips. If necessary, the media chamber 14 of the inner piston accumulator 74 can also carry ambient air and be kept depressurised. In the respective other media chambers 16 of the piston accumulators 74 and 76, which are directed towards each other within the rotor blade 68, the incompressible medium, such as hydraulic fluid, is located as a mass which can be displaced within a relevant rotor blade 68 to compensate imbalance. These fluid-conducting media chambers 16, which are directed towards each other, are connected to each other via a fluid line 78, for example in the form of a pipe or a hose. A control valve 80, for example in the form of an electromagnetically actuated switching valve which can be centrally controlled by a control system 82, is arranged in the respective fluid line 78 adjacent to the respective inner piston accumulator 74. To transmit the values of lateral accelerations acting on the support structure of the wind turbine transverse to the rotor shaft to the control system 82, an acceleration sensor 84 is arranged in the tower head or the nacelle 72, which sensor is connected to the control system 82 via corresponding measurement signal lines. Furthermore, a rotor position sensor 86 is provided which, in the form of a rotor speed sensor or a rotor rotational position sensor on the rotor shaft, determines the position of the rotor blades 68 and transmits it to the control system 82 via a further measurement signal line.

To carry out an imbalance compensation process using the balancing device, the wind turbine is brought into an initial state by increasing the rotor speed by motor to a speed at which the hydraulic fluid, which is located in the fluid-conducting media chambers 16 of the piston accumulators 74, 76 and in the fluid line 78 therebetween, is displaced outwards towards the blade tips under the effect of the centrifugal force when the control valves 80 are open and the working gas in the respective media chamber 14 of the outer piston accumulators 76 is thereby compressed so that they are in a state of charge. To detect the presence of an imbalance, the wind turbine must be operated at a critical speed and, if an imbalance is present, operation at these speeds results in lateral vibrations of the tower and thus to the occurrence of acceleration signals of the acceleration sensor 84. The determination of which of the rotor blades 68 has a deviating mass moment of inertia is carried out with the aid of the rotor rotational position sensor on the rotor shaft, which determines the precise position of the rotor blades 68 at any time. From the instantaneous value of the lateral acceleration of the rotor position, the control system 82 determines which rotor blade 68 has the deviating mass moment of inertia and provides a control signal for the control valves 80, which partially discharge the charged piston accumulators 76 in question in order to shift the mass of the incompressible hydraulic fluid in such a manner that lateral acceleration is no longer measured. The rotor is then balanced as a whole.

It is understood that during operation of the rotor blades 68, deformations due to bending forces occur as a result of the influence of wind force, also during the occurrence of turbulence, in particular bending of the respective rotor blade 68 in its longitudinal orientation. Thanks to the piston accumulator solution described above using an accumulator housing 10 and/or a separating piston 12 which are flexible to bending, the respective bending deformations of the rotor blade 68 can be absorbed in this way in all directions, the piston accumulator pairs 74, 76 also being able to perform a functionally reliable mass balancing to compensate for the imbalance of the rotor blades 68 even in the event of the deflection described.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality, A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A piston accumulator comprising an accumulator housing and a separating piston which is arranged so as to be longitudinally movable therein and separates two media chambers from each other inside the accumulator housing, wherein the accumulator housing in sandwich design is elastically constructed from individual layers some of which are different from one another, in such a manner that under the action of at least one external force, starting from an initial state, the accumulator housing allows for a curvature as a whole and returns to the initial state with the removal of the respective force.

12. The piston accumulator of claim 11, wherein the sandwich design results in a linear-elastic behaviour for the accumulator housing.

13. The piston accumulator of claim 11, wherein, as part of the sandwich design, the innermost layer of the accumulator housing is impermeable to gas and wherein the respective subsequent outward layer is formed of a fibre winding.

14. The piston accumulator of claim 11, wherein, in terms of wall thickness, the first innermost layer is a thin steel tube.

15. The piston accumulator of claim 13, wherein the respective fibre winding for the accumulator housing has a different winding direction than the preceding winding direction in the winding sequence in each case.

16. The piston accumulator of claim 13, wherein, on at least one free end face of the accumulator housing, a connecting part is partially enclosed by at least part of the fibre windings.

17. The piston accumulator of claim 13, wherein the connecting part is at least partially penetrated on its cylindrical inner circumference by the innermost layer and has an annular receiving groove on the outer circumference for receiving fibre layers of the individual windings.

18. The piston accumulator of claim 11, wherein the receiving groove is at least partially bounded by a fixing ramp against which at least one inner fibre winding is placed and which is overlapped by at least one subsequent fibre winding that is further outward-facing.

19. The piston accumulator of claim 11, wherein at least one outer fibre winding is penetrated by a plurality of retaining pins.

20. The use of a piston accumulator for a wind turbine as part of a balancing device to compensate for the imbalance of the rotor blades of such a wind turbine, of which at least one rotor blade is firmly connected to the accumulator housing of the piston accumulator at discrete fixing points.

21. The piston accumulator of claim 12, wherein, as part of the sandwich design, the innermost layer of the accumulator housing is impermeable to gas and wherein the respective subsequent outward layer is formed of a fibre winding.

22. The piston accumulator of claim 11, wherein, in terms of wall thickness, the first innermost layer is a thin steel tube which is produced by means of flow-forming and which forms the running surface for the separating piston on the inner circumference.

23. The piston accumulator of claim 12, wherein, in terms of wall thickness, the first innermost layer is a thin steel tube.

24. The piston accumulator of claim 13, wherein, in terms of wall thickness, the first innermost layer is a thin steel tube.

25. The piston accumulator of claim 21, wherein the respective fibre winding for the accumulator housing has a different winding direction than the preceding winding direction in the winding sequence in each case.

26. The piston accumulator of claim 24, wherein the respective fibre winding for the accumulator housing has a different winding direction than the preceding winding direction in the winding sequence in each case.

27. The piston accumulator of claim 15, wherein, on at least one free end face of the accumulator housing, a connecting part is partially enclosed by at least part of the fibre windings.

28. The piston accumulator of claim 15, wherein the connecting part is at least partially penetrated on its cylindrical inner circumference by the innermost layer and has an annular receiving groove on the outer circumference for receiving fibre layers of the individual windings.

29. The piston accumulator of claim 16, wherein the connecting part is at least partially penetrated on its cylindrical inner circumference by the innermost layer and has an annular receiving groove on the outer circumference for receiving fibre layers of the individual windings.

30. The piston accumulator of claim 11, wherein at least one outer fibre winding is penetrated by a plurality of retaining pins which are at a constant distance from one another and which pass through the connecting part viewed in the radial direction.
